(19) United States
(12) Patent Application Publication
(10) Pub. No.: US 2006/0230685 A1
(43) Pub. Date: Oct. 19, 2006

(54) Appearance feature for polyurethane glass bond

(76) Inventor: Paul Michel Bellemare, Waterford, MI (US)

Correspondence Address: BRINKS HOFER GILSON & LIONE, P.O. BOX 10395, CHICAGO, IL, 60610, US

(21) Appl. No.: 11/107,290

(22) Filed: Apr. 15, 2005

(51) Int. Cl. E06B 7/16

(52) U.S. Cl. 49/496.1; 49/475.1

(57) ABSTRACT

An appearance feature for a weatherstrip or seal bonded directly to a glass window or light includes a seal assembly comprising molded material and polyurethane bonded directly to the glass and an applique which is secured to the polyurethane material before it cures. The applique may be of any material having suitable shape, color, appearance and weatherability. The applique includes a first, appearance surface and a second, attachment surface which includes projecting pins, chevrons, loops, stirrups and the like which are mechanically held in the polyurethane when it has cured.

### BACKGROUND OF THE INVENTION

The invention relates generally to appearance features for use on motor vehicle glass and more particularly to an appearance feature for providing a show surface on a polyurethane glass bond on a motor vehicle window.

An art has developed regarding the means and mechanisms whereby glass windows or lights are mounted and secured within openings of motor vehicle bodies and doors. For many years, stationary glass lights were surrounded by a preformed peripheral gasket fabricated as a continuous extrusion which was subsequently cut to length. The ends of the gasket would then be secured together and the assembly installed in an opening of the motor vehicle. In a later developed technology, the gasket was formed as a continuous undersized loop in a mold and was then stretched to engage the periphery of a glass light.

Further developments involved the in-situ molding of the gasket directly on the glass light in a suitable mold which received the glass and included a peripheral gasket forming cavity.

A variation of solid peripheral in-situ gasket molding involves bonding gaskets or weatherstrips on one face of a glass light. Such glass lights may be utilized, for example, as hinged vent windows. While such configurations provide both the necessary seal and live hinge functions, the bonded area, since it may be either on the outside of the glass or be visible from the outside of the glass, may have an unacceptable appearance. That is, both the appearance of the material or materials themselves as well as the appearance of the seal configuration may be deemed unacceptable.

The present invention is directed to improvements in weatherstrips and seals bonded directly to a glass window or light.

### SUMMARY OF THE INVENTION

An appearance feature for a weatherstrip or seal bonded directly to a glass window or light includes a gasket seal assembly comprising molded material and polyurethane bonded directly to the glass and an applique which is secured to the polyurethane material before it cures. The applique may be of any material having suitable shape, color, appearance and weatherability. The applique includes a first, appearance surface and a second, attachment surface which includes projecting pins, chevrons, loops, stirrups and the like which are mechanically held in the polyurethane when it has cured. An alternate embodiment weatherstrip utilizes double sided tape to secure the appliqué to the seal.

It is thus an object of the present invention to provide an appearance feature for a weatherstrip bonded directly to a glass light.

It is a further object of the present invention to provide an appearance feature having a desired color and appearance for attachment to a gasket or seal bonded directly to a glass light.

It is a still further object of the present invention to provide an appearance feature having a show surface and which is mechanically secured to a glass polyurethane bond.

Further objects and advantages of the present invention will become apparent by reference to the following description of the preferred embodiment and appended drawings wherein the like reference numbers refer to the same component, element or feature.

### BRIEF DESCRIPTION OF THE DRAWINGS

FIG. 1 is a fragmentary, side elevational view of a motor vehicle illustrating the present invention;

FIG. 2 is an enlarged, full sectional view of an in-situ molded polyurethane weatherstrip and applique according to the present invention, taken along line 2-2 of FIG. 1;

FIG. 3 is an enlarged, full sectional view of an alternate embodiment applique attachment structure according to the present invention;

FIG. 4 is an enlarged, full sectional view of an in-situ molded polyurethane weatherstrip on a glass light according to the present invention;

FIG. 5 is an enlarged, full sectional view of an in-situ molded polyurethane weatherstrip shown during the installation of an applique;

FIG. 6 is an enlarged, full sectional view of an alternate embodiment applique attachment method according to the present invention; and

FIG. 7 is an enlarged, full sectional view of the alternate embodiment applique attachment method and in-situ molded polyurethane weatherstrip.

### DETAILED DESCRIPTION OF THE INVENTION

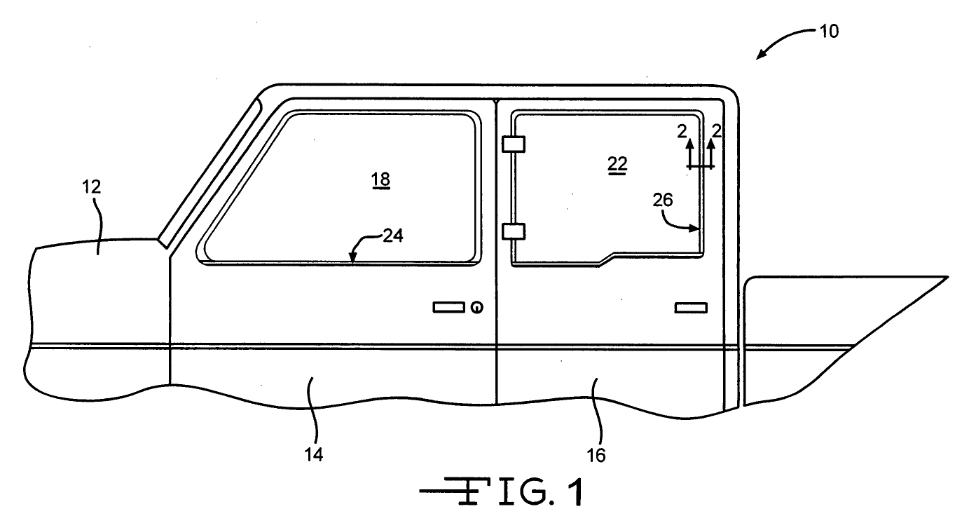

Referring now to FIG. 1, a partial, side elevational view of a four-door motor vehicle such as a pick-up truck, sport utility vehicle (SUV) or hybrid sport utility vehicle is illustrated and designated by the reference number 10. It is to be noted that such illustration is exemplary only and it will be appreciated that the present invention may also be utilized in passenger vehicles, truck cabs, tractor cabs and the like. The motor vehicle 10 includes a body 12, a front door 14, a rear door 16, a moveable front window 18, a moveable rear window 22, a front weatherstrip assembly 24 secured to the front door 14 about the opening receiving the moveable front window 18 and a rear weatherstrip assembly 26 secured to the rear window or glass light 22 which provides a seal to an adjacent portion of the rear door 18. The front weatherstrip assembly 24 functions to aesthetically conceal the interface between the front door 14 and the front window 18. Since the rear window 22 is hinged, however, the weatherstrip 26 functions to seal the periphery of the glass light 22 to the adjacent portion of the vehicle 10.

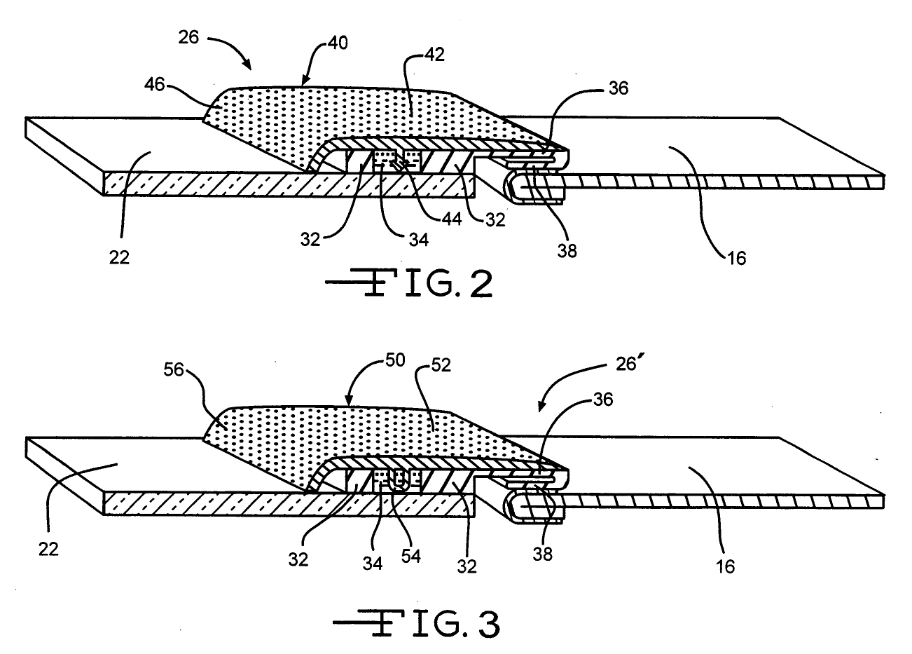

Referring now to FIG. 2, the weatherstrip 26 includes first and second regions of molding material 32 which may be ethylene propylene diene monomer (EPDM), a thermoplastic elastomer (TPE) or a polyvinylchloride (PVC). Between the two regions of molding material 32 is a region of polyurethane 34. The molding material 32 is in-situ molded to the glass light 22 in a suitable molding cavity (not illustrated). Depending upon the type of molding material 32 and the degree of adhesion required, a primer layer (not illustrated), may be applied to the glass light 22 before application of the molding material 32. The molding material 32 is formed into a flexible, J-shaped flange 36 which extends outwardly from the glass light 22 and includes a curved end or return 38 which facilitates a seal with the door 16 as will be readily appreciated.

An applique 40 having an outwardly directed show surface 42 fully covers the molding material 32 as well as the flange 36 and engages the glass light 22 thereby providing an aesthetically pleasing appearance to the peripheral portion of the glass light 22. The applique 40 defines a curved end or return 46 which is adapted to engage the glass light 22 and hide the molding material 32 and the polyurethane 34. The applique 40 also includes a securement structure 46 extending from its surface opposite the show surface 42 such as a continuous chevron or arrowhead shaped feature which securely retains the applique 40 within the polyurethane 34.

Referring now to FIG. 3, a first alternate embodiment weatherstrip 26′ is illustrated. The weatherstrip 26′ includes two spaced apart regions of molding material 32 and an intermediate region of polyurethane 34. The region of molding material 32 adjacent the edge of the glass light 22 extends beyond the glass light 22, forms a J-shaped flange 36 and includes a flexible terminal portion or return 59 which facilitates and ensues a secure, weather tight seal with and against the door 16. The weatherstrip 26′ also includes an appliqué 50 having a show surface 52 and a centrally disposed U-shaped plurality of discrete, i.e., discontinuous or spaced apart, anchors 54 which embed within the polyurethane 34 to retain the applique 50 adjacent the glass light 22. The applique 50 likewise includes a curved, edge or return 56 which engages the glass light 22.

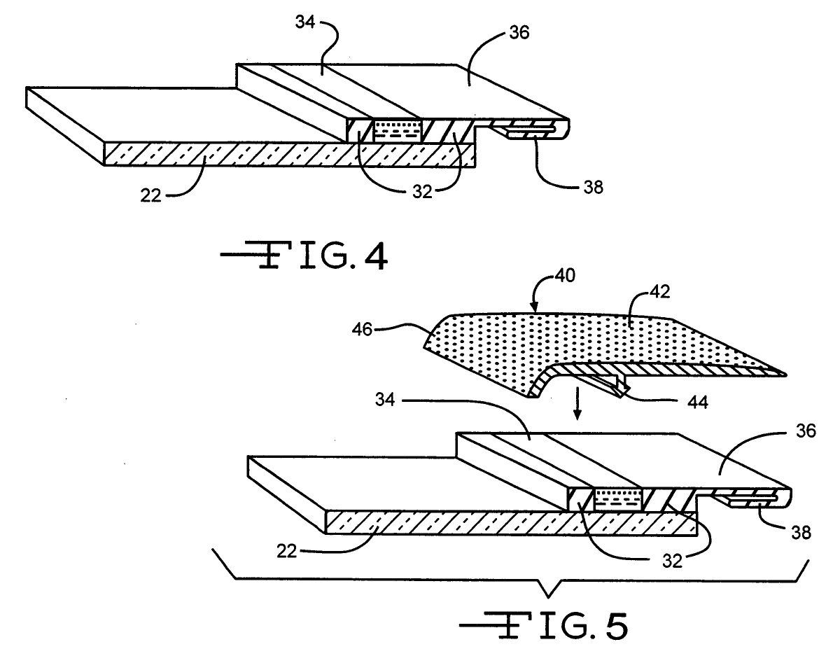

Referring now to FIGS. 4 and 5, a first method of assembly of the weatherstrip 26 or the first alternate embodiment weatherstrip 26′ is illustrated. First of all, the window or glass light 22 is washed or cleaned by any conventional and well known process such that the glass light 22 is free of dust, grease or other foreign substances which might interfere with the positive and secure adhesion of the molding material 32 and the polyurethane 34 to it. Depending upon the particular materials used for these features, it may be desirable or necessary to apply a primer layer (not illustrated) to the glass light 22 after cleaning and before emplacement of the molding material 32 and the polyurethane 34 thereon. Emplacement of the molding material 32 is preferably achieved in a conventional two-piece mold (not illustrated) having upper and lower sections which cooperatively receive the glass light 22 and include peripheral channels which correspond with the desired cross-section and configuration of the molding material 32. The molding material 32 is then preferably cured and the glass light 22 with the regions of molding material 32 secured thereto is removed from the mold.

The space between the two strips of molding material 32 is then filled with liquid polyurethane at an elevated temperature. Before the polyurethane 34 cools and solidifies, the appliqué 40 or 50 is assembled to the molding material 32 and glass light 22 such that when the polyurethane 34 cools and solidifies, the appliqués 40 and 50 are retained therein.

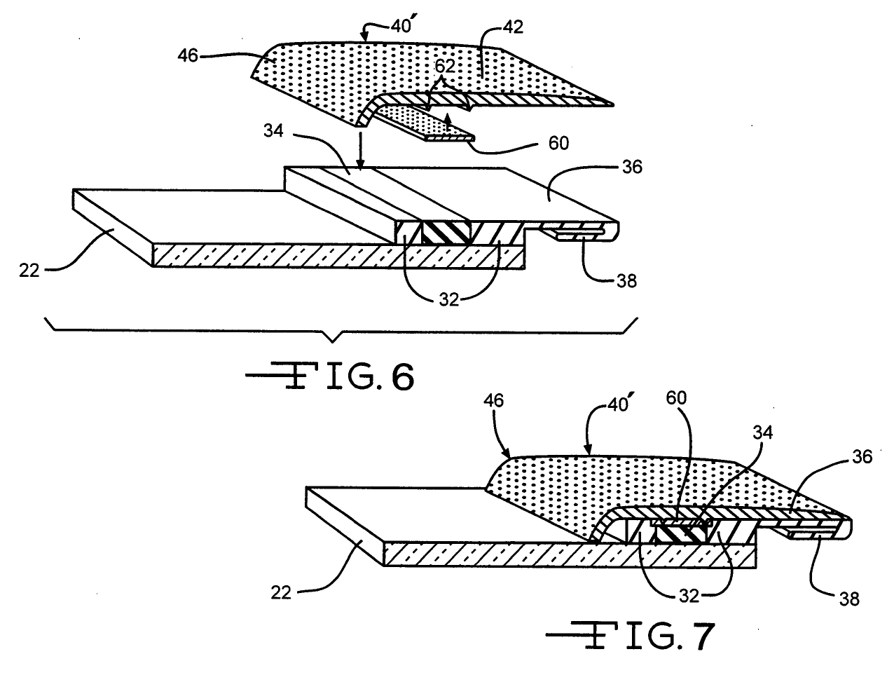

Referring now to FIGS. 6 and 7, an alternate attachment method for an appliqué 40′ utilizes a strip of double sided tape 60. The double sided tape 60 includes durable, weather resistant, pressure sensitive adhesive on both its upper and lower surfaces. The appliqué 40′ includes a pair of small preferably continuous locating ribs 62 on its inside opposite its show surface 64 or underside which are shown somewhat enlarged for purposes of clarity. The locating ribs 62 generally identify that region of the appliqué 40′ upon which the double sided tape 60 is preferably secured. After fabrication of the molding material 32 and subsequent addition of the polyurethane 34 and allowing the polyurethane 34 to fully cool, the appliqué 40′ with the attached double sided tape 60 is pressed into position as illustrated in FIG. 7, completing assembly of the appliqué 40′ and the weatherstrip onto the glass light 22. Once again, it may be necessary or advisable, depending upon the materials utilized to apply a suitable primer to the surfaces engaged by the double sided tape 60.

The foregoing disclosure is the best mode devised by the inventors for practicing this invention. It is apparent, however, that devices incorporating modifications and variations will be obvious to one skilled in the art of sealing and appearance features for use on motor vehicle glass. Inasmuch as the foregoing disclosure is intended to enable one skilled in the pertinent art to practice the instant invention, it should not be construed to be limited thereby but should be construed to include such aforementioned obvious variations and be limited only by the scope and spirit of the following claims.

1. A weatherstrip for a motor vehicle comprising, in combination,
a pair of spaced apart elongate molded members defining an intermediate region, said intermediate region containing polyurethane, and
an appliqué for disposition over said members and polyurethane, said appliqué including a planar body portion having a curved end region and an attachment assembly for securement to said polyurethane.

2. The weatherstrip of claim 1 wherein said attachment assembly is an elongate, continuous member.

3. The weatherstrip of claim 2 wherein said continuous member is arrow-shaped and extends from said appliqué.

4. The weatherstrip of claim 2 wherein said continuous member is double sided tape.

5. The weatherstrip of claim 1 wherein said attachment assembly is discontinuous and includes a plurality of spaced-apart, U-shaped members.

6. The weatherstrip of claim 1 wherein one of said molded members includes a flange having a curved end portion.

7. The weatherstrip of claim 1 wherein said elongate molded members reside on a glass light.

8. A weatherstrip for a motor vehicle comprising, in combination,
a pair of spaced apart elongate molded members defining an intermediate region, one of said molded members including a flange having a curved end portion, said intermediate region containing polyurethane, and
an appliqué for disposition over said members and said polyurethane, said appliqué including a planar body portion having a curved end region and an attachment assembly for securement to said polyurethane.

9. The weatherstrip of claim 8 wherein said attachment assembly is an elongate, continuous member.

10. The weatherstrip of claim 9 wherein said continuous member is arrow-shaped and extends from said appliqué.

11. The weatherstrip of claim 9 wherein said continuous member is double sided tape.

12. The weatherstrip of claim 8 wherein said attachment assembly is discontinuous and includes a plurality of spaced-apart, U-shaped members

13. The weatherstrip of claim 8 wherein said applique includes a show surface.

14. A weatherstrip for a motor vehicle comprising, in combination,
a pair of spaced apart elongate members molded to a glass light, said members defining an intermediate region, one of said molded members including a flange extending beyond such glass light, and said intermediate region containing polyurethane, and
an appliqué for disposition over said members and said polyurethane, said appliqué including a planar body portion having a curved end adapted to engage such glass light and an attachment assembly for securement to said polyurethane.

15. The weatherstrip of claim 14 wherein said attachment assembly is an elongate, continuous member.

16. The weatherstrip of claim 15 wherein said continuous member is arrow-shaped and extends from said appliqué.

17. The weatherstrip of claim 15 wherein said continuous member is double sided tape.

18. The weatherstrip of claim 14 wherein said attachment assembly is discontinuous and includes a plurality of spaced-apart, U-shaped loops.

19. The weatherstrip of claim 14 wherein said attachment assembly is discontinuous and includes a plurality of spaced-apart U-shaped members.

20. The weatherstrip of claim 14 wherein said applique includes a show surface.
